(19) United States
(12) Patent Application Publication
(10) Pub. No.: US 2022/0274642 A1
(43) Pub. Date: Sep. 1, 2022

(54) System and method for controlling the lateral movement of the autonomous vehicles with a non linear steering system.

(71) Applicant: Thordrive, Inc., Cincinnati, OH (US)

(72) Inventors: Kyoochul Lee, Cincinnati, OH (US); Seyed Ataollah Raziei, Dayton, OH (US)

(73) Assignee: Thordrive, Inc., Cincinnati, OH (US)

(21) Appl. No.: 17/681,234

(22) Filed: Feb. 25, 2022

Related U.S. Application Data
(60) Provisional application No. 63/154,081, filed on Feb. 26, 2021.

(51) Int. Cl. B62D 6/00; B62D 15/02; B62D 5/09; B62D 5/12

(52) U.S. Cl. CPC B62D 6/002; B62D 15/0225; B62D 5/091; B62D 5/12

(57) ABSTRACT

The present invention relates to a steering control system and method for a vehicle, and more particularly a control system and method for accurately controlling the lateral movement of an autonomous vehicle that has a non-linear steering system, e.g., a hydraulic steering system, which includes measuring wheel angles of the vehicle, calculating the actuation value for the desired wheel angle based on the measured wheel angle, and rotating the steering wheel according to the actuation value; wherein the actuation values are calculated based on a function f( ) representing the nonlinear behavior of the steering ratio depending on the position and movement direction of the steering wheel, and another function g( ) representing a response lag when the steering direction is changed.

### FIELD

The present invention relates to a steering control system and method for a vehicle and, more particularly, a steering control system and method for accurately controlling the lateral movement of an autonomous vehicle that has a non-linear steering system, e.g., a hydraulic steering system.

### BACKGROUND

It is crucial for an autonomous vehicle to have a precise lateral control system to accurately track a desired path by controlling the steering wheel of a vehicle in a desired direction. Normally, it consists of hardware and software that measures the wheel status with a sensor system, a set of logic in the software running on top of a computing system that calculates a desired angle at which a motor should turn the steering wheel, and the motor that turns the wheel to pursue the desired wheel angle.

Such control system is highly correlated with the steering system that a vehicle platform is equipped with. The electric power steering system is most commonly used where an electric motor assists the driver in steering the vehicle. Because of the characteristic of an electric motor, the steering wheel angle (SWA) and the front wheel angle (FWA) in a vehicle with an electric power steering system maintain a linear and consistent relationship as in Equation (1):

SWA=a₁×FWA (a₁ is constant) (1)

Because of this linear and consistent relationship between SWA and FWA, most autonomous vehicles with electric power steering systems sense and control SWA instead of FWA. Therefore, the control system of an autonomous vehicle with the electric power steering system consists of a sensor part that measures the steering wheel angle, an actuation part that is attached to the steering wheel or steering column and turns the steering wheel, and a computing part that is equipped with software to calculate the desired actuation value based on the linear relationship between SWA and FWA.

While the electric power steering system is the most common and popular for general purpose vehicles, the hydraulic steering system is also widely used for those vehicles that carry heavy loads. In the hydraulic steering system, a hydraulic cylinder amplifies force applied to the steering wheel and transfers it to the front axle as shown in FIG. 1. Because of the nature of the hydraulic cylinder, the relationship between the SWA and the FWA in the hydraulic steering system is nonlinear, as shown in FIG. 2. It shows a difference in the change of FWA depending on whether the steering wheel is turned to the right or left, which means the front wheels don't come to the original position when the steering wheel is turned 360 degrees right and turned back 360 degrees left. This makes it difficult to estimate the FWA accurately by measuring the SWA.

As shown in FIG. 2, there is a response lag in the hydraulic steering system when the steering direction is changed. Because the system uses pressurized fluid to push the hydraulic cylinder, the system takes time to change the direction of the cylinder, which causes a delay in the system response when an input is applied.

Because of the nonlinearity and response lag of the hydraulic steering system, its measured values do not match the desired values, as shown in FIG. 3. This causes the vehicle to sway from the center of the lane to the left and right, which reduces the driving safety to a great extent. The present invention is intended to solve this problem.

### SUMMARY

The present invention is about a system and method that solves this problem and enables accurate lateral control of the autonomous vehicle by incorporating new sensing apparatus to measure the front (or rear) wheel angle and new logic to handle the system's nonlinearity and response lag.

A control system for an autonomous vehicle with a nonlinear steering system, according to an embodiment of the present invention for solving the technical problem, includes a sensing part that measures the wheel angle; a computing unit that calculates actuation values for the desired wheel angle based on the measured wheel angle; an actuation part that rotates the steering wheel according to the actuation value, wherein the actuation values are calculated based on a function f( ) representing the nonlinear behavior of the steering ratio depending on the position and movement direction of the steering wheel; and another function g( ) representing a response lag when the steering direction is changed.

According to an embodiment of the present invention, the actuation part includes a DC motor actuator and a gearbox, which is linked to a steering column of the steering system.

According to an embodiment of the present invention, the sensor part includes a wire sensor that measures the change of wire as the wheel rotates.

According to an embodiment of the present invention, the sensor part includes a rotary angle sensor that measures the rotation angle of the wheel.

According to an embodiment of the present invention, the sensor part converts a measured value to the corresponding wheel angle by a mapping table.

According to an embodiment of the present invention, the functions f( ) and g( ) are expressed by lookup tables respectively, which are obtained by measuring the wheel angles with respect to the actuation values.

According to an embodiment of the present invention, the wheel angles are measured with a laser level device which is attached to the center of the wheel and projects a laser beam parallel to the wheel.

According to an embodiment of the present invention, the laser level device is attached to the wheel by an attachment disk, which includes disk magnets on its back side.

According to an embodiment of the present invention, the laser beam is projected to reach the floor.

According to an embodiment of the present invention, the attachment disk is thick enough so that the body of the vehicle does not block the path of the laser beam to the floor.

According to an embodiment of the present invention, the angle between the laser beam and a stick tape attached to the floor parallel to the front axle on the floor is measured, and the FWA is obtained by subtracting the measured angle from 90 degrees.

According to an embodiment of the present invention, the lookup table for f( ) is obtained by changing the FWA by a predetermined unit angle, applying an actuation value to the actuation part for each FWA, and measuring the new FWA for this case, where the effect of g( ) is ignored.

According to an embodiment of the present invention, the lookup table for g( ) is obtained by changing the FWA by a predetermined unit angle, applying an actuation value to the actuation part for each FWA, and measuring the new FWA for this case, while the effect of f( ) is deducted by using the lookup table for f( ).

A control method for an autonomous vehicle with a nonlinear steering system according to one embodiment of the present invention for solving the technical problem includes measuring wheel angles of the vehicle, calculating the actuation value for the desired wheel angle based on the measured wheel angle, and rotating the steering wheel according to the actuation value, wherein the actuation values are calculated based on a function f( ) representing the nonlinear behavior of the steering ratio depending on the position and movement direction of the steering wheel and another function g( ) representing a response lag when the steering direction is changed.

According to an embodiment of the present invention, the functions f( ) and g( ) are expressed by lookup tables respectively, which are obtained by measuring the wheel angles with respect to the actuation values.

According to an embodiment of the present invention, the wheel angles are measured with a laser level device that is attached to the center of the wheel and projects a laser beam in parallel to the wheel to reach the floor.

According to an embodiment of the present invention, the angle between the laser beam and a stick tape attached to the floor parallel to the front axle on the floor is measured and the FWA is obtained by subtracting the measured angle from 90 degrees.

According to an embodiment of the present invention, the lookup table for f( ) is obtained by changing the FWA by a predetermined unit angle, applying an actuation value to the actuation part for each FWA, and measuring the new FWA for this case, where the effect of g( ) is ignored.

According to an embodiment of the present invention, the lookup table for g( ) is obtained by changing the FWA by a predetermined unit angle, applying an actuation value to the actuation part for each FWA and measuring the new FWA for this case, while the effect of f( ) is deducted by using the lookup table for f( ).

According to an embodiment of the present invention, the wheel angles are obtained by converting the output values of a sensor to the corresponding wheel angles by a mapping table.

### BRIEF DESCRIPTION OF THE DRAWINGS

FIG. 1 is a schematic depiction illustrating mechanical linkage through the fluid pressure in the hydraulic steering system.

FIG. 2 is a graph illustrating measured angles of the front wheels according to positions of the steering wheel in the hydraulic steering system.

FIG. 3 is a graph illustrating desired and measured FWAs of a vehicle with the hydraulic steering system when it is driven along the straight line.

FIG. 4 is a schematic depiction illustrating a steering system in which a motor and a gearbox are installed to the steering column of the hydraulic steering system according to an embodiment of the present invention.

FIG. 5 is a schematic depiction illustrating the installation of a linear wire sensor to measure the front wheel angle according to an embodiment of the present invention.

FIG. 6 is a schematic depiction illustrating the installation of a rotary angle sensor to measure the front wheel angle according to an embodiment of the present invention.

FIG. 7 is a schematic depiction illustrating an attachment disk with a laser level device attached to a wheel of a vehicle according to an embodiment of the present invention.

FIG. 8 is a side view illustrating a front wheel with an attachment disk and its laser beam projected to the ground according to an embodiment of the present invention.

FIG. 9 is a schematic diagram illustrating the measurement setup of the front wheel angle according to an embodiment of the present invention.

FIG. 10 is a real picture of the measurement setup of the FWA according to an embodiment of the present invention.

FIG. 11 is a graph illustrating desired and measured FWAs of a vehicle equipped with a steering system according to an embodiment of the present invention.

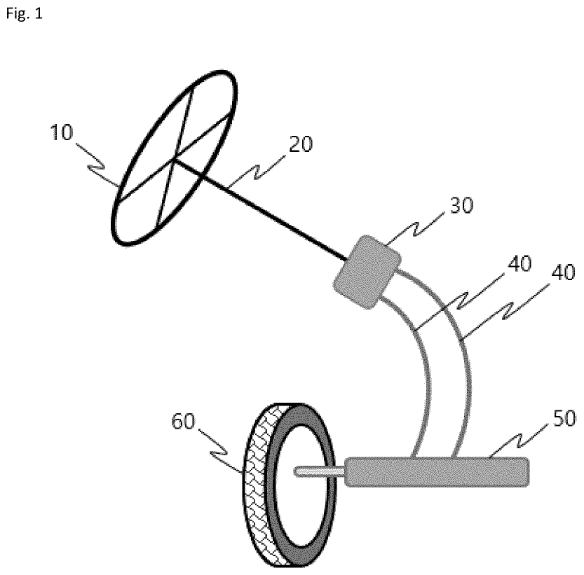

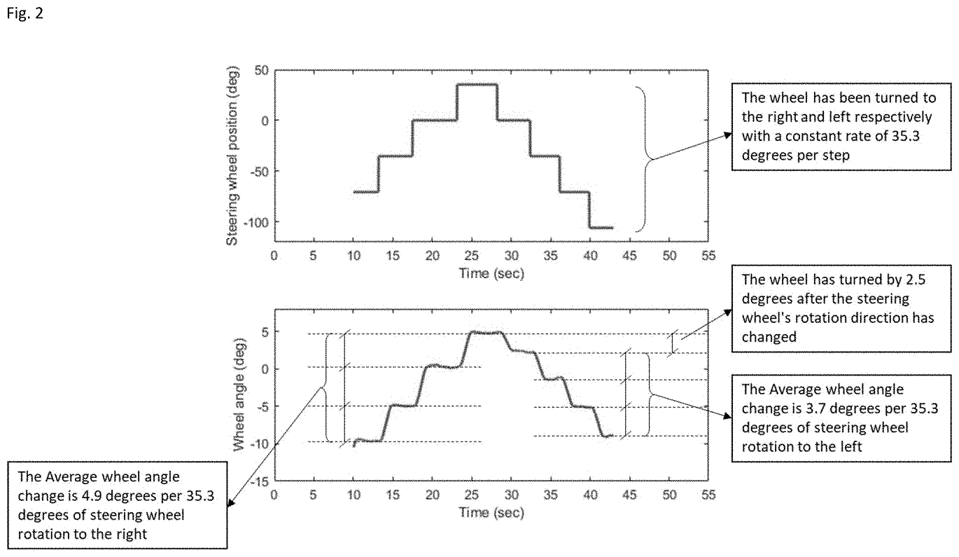

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth to provide a thorough understanding of the invention. However, it will be understood by those skilled in the art that the present invention may be practiced without these specific details. In other instances, well-known methods, procedures, and components have not been described in detail so as not to obscure the present invention. It may be readily understood that certain aspects of the disclosed systems and methods can be arranged and combined in a wide variety of different configurations, all of which are contemplated herein.

Although the following detailed description is made based on the front wheel for convenience of understanding, it is obvious to those skilled in the art that the same can be applied to steering of the rear wheel.

The present invention relates to a steering control system and method for a vehicle and, more particularly, a steering control system and method for accurately controlling the lateral movement of an autonomous vehicle that has a non-linear steering system, e.g., a hydraulic steering system.

The present invention may include an actuation part 100 that turns the steering wheel, a sensor part 200 that measures the front wheel angle, and a computing unit 300 that runs software to calculate the desired actuation values. The present invention also provides a method for modeling a nonlinear steering system, which is the core logic of the software.

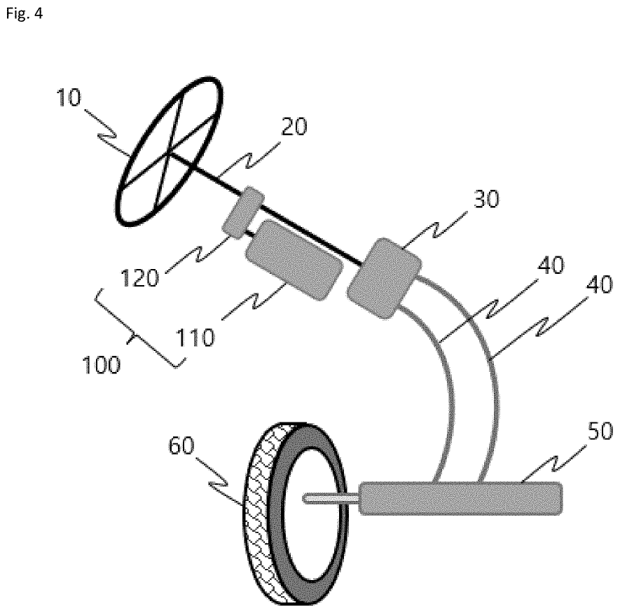

FIG. 4 illustrates an embodiment of a steering system according to the present invention.

The steering system according to the present invention is based on the hydraulic steering system composed of a steering wheel 10, steering column 20, steering pump 30, fluid lines 40, hydraulic cylinder 50, and wheels 60. When the steering wheel 10 is turned by a driver in the hydraulic steering system, the torque is transferred to the steering pump 30 through the steering column 20. It makes the steering pump 30 push the fluid into the hydraulic cylinder 50 through the fluid lines 40, and so the road wheels 60 are controlled by the hydraulic cylinder 50.

According to one embodiment of the present invention, an actuation part 100, including a DC motor actuator 110 and a gearbox 120, may be installed to the steering column 20 of the hydraulic steering system as in FIG. 4. Since the actuation part is mechanically linked to the steering column 20, it can rotate the steering column 20 in a desired direction by a desired angle. In one embodiment of the present invention, a commercially available DC motor actuator can be adopted as the DC motor actuator 110. The DC motor actuator 110 is electronically connected to a computing part through the CAN (Car Area Network) bus through which it receives the desired actuation value and sends the measured value.

According to one embodiment of the present invention, a sensor part 200 may be mechanically connected to a part of a wheel 60 to measure its angle.

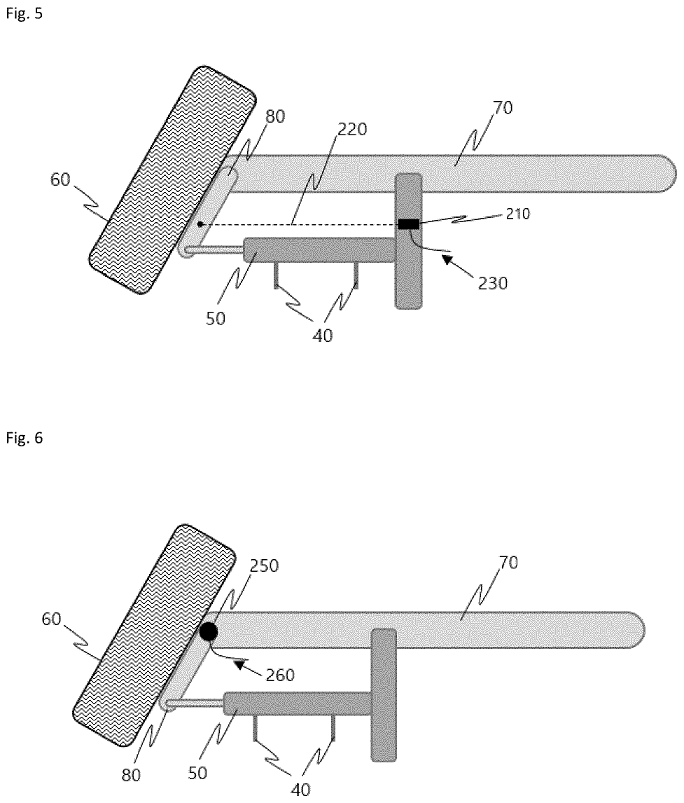

FIG. 5 illustrates the installation of a wire sensor to measure the wheel angle according to one embodiment of the present invention.

The sensor part 200 may include a wire sensor 210 to measure the angle of the wheel 60, as shown in FIG. 5. The length of the wire 220 is changed as the wheel 60 rotates, and the change of the wire 220 is proportional to the rotation of the wheel 60. The wire sensor 210 outputs a voltage corresponding to the measured length of the wire 220. When the output voltage of the wire sensor 210 is proportional to the wheel angle, the wheel angle can be calculated simply by multiplying the output voltage by a constant. Otherwise, the wheel angle can be obtained by using a mapping table. The mapping table for a wire sensor 210 can be constructed by measuring the wheel angle and recording the corresponding output voltage of the wire sensor 210 while changing the wheel angle.

The measured value of the wire sensor 210 can be transferred to the computing unit 300 through a sensor cable 230, which is connected to the CAN bus of the vehicle.

FIG. 6 illustrates the installation of a rotary angle sensor to measure the wheel angle according to another embodiment of the present invention.

The sensor part 200 may include a rotary angle sensor 250 that is placed at the junction of the front axle 70 and the tiller arm 80, as shown in FIG. 6. The rotary angle sensor 250 outputs a voltage corresponding to the measured angle. When the output voltage of the rotary angle sensor 250 is proportional to the wheel angle, the wheel angle can be calculated simply by multiplying the output voltage by a constant. Otherwise, the wheel angle can be obtained by using a mapping table. The mapping table for the rotary angle sensor 250 can be constructed by measuring the wheel angle and recording the corresponding output voltage of the rotary angle sensor 250 while changing the wheel angle.

The measured value of the rotary angle sensor 250 can be transferred to the computing unit 300 through a sensor cable 260, which is connected to the CAN bus of the vehicle.

According to one embodiment of the present invention, the computing unit 300 may receive the measured values from the sensor part 200 and provide desired actuation values to the actuation part 100 based on the measured values.

The software system that runs on the computing unit 300 may take the desired front wheel angle as an input from an autonomous driving system, read the measured front wheel angle at the corresponding moment, and produce the desired actuation value to control the steering wheel 10. The desired actuation value may be represented as:

y_{d}=f(x_{d},xₘ)×e+g(Δx_{d},xₘ)+yₘ (2)
y_{d}: desired actuation value
yₘ: measured (current) actuation value
x_{d}: desired front wheel angle
xₘ: measured (current) front wheel angle
e: x_{d}−xₘ
   in which f( ) is a function that represents the nonlinear behavior of the steering ratio depending on the position and movement direction of the hydraulic cylinder 50, and g( ) is a function representing a response lag that is non-zero when the steering direction is changed.

In one embodiment of the present invention, f( ) and g( ) may be expressed by mathematical equations for modeling the nonlinearity and response lag of the hydraulic steering system, respectively.

In another embodiment of the present invention, f( ) and g( ) may be expressed by lookup tables that are obtained by a measurement experiment. For example, a lookup table for obtaining f( ) values corresponding to x_{d} and xₘ and another lookup table for obtaining g( ) values corresponding to Δx_{d} and xₘ may be used. Each of lookup tables can be obtained by precise measurement of FWAs with respect to actuation values applied to the steering wheel 10.

This approach is based on piecewise linearization, where different steering ratios, SRᵢ are used in the linearized equations depending on the state of the steering system. The piecewise linear equation between the change of the FWA (Δbᵢ) and the change of the SWA (ΔW) for the “i”th linearized segment can be expressed using the steering ratio SRᵢ as follows:

Δbᵢ=SRᵢ*ΔW (3)

When the steering wheel is rotated by ΔW in the ith linearized segment, the front wheel rotates by Δbᵢ according to the steering ratio SRᵢ of the ith linearized segment. So, when the current FWA xₘ is measured as corresponding to the ith linearized segment, the desired ΔW for the desired FWA x_{d} is proportional to the reciprocal of the steering ratio SRᵢ as follows:

$$Δ W = \frac{Δ {b}_{i}}{{SR}_{i}} = \frac{{x}_{d} - {x}_{m}}{{SR}_{i}} \qquad ( 3 )$$

Assuming that ΔW is proportional to the change of the actuation value (ΔY=y_{d}−yₘ) as ΔW=3 ΔY, the actuation value for the desired FWA x_{d} can be calculated as follows:

$${y}_{d} = \frac{{x}_{d} - {x}_{m}}{β \cdot {SR}_{i}} + {y}_{m} \qquad ( 4 )$$

If the effect of g( ) is ignored, f( ) corresponds to 1/(β·SRᵢ), which can be obtained by precise measurement of FWAs with respect to actuation values applied to the steering wheel 10.

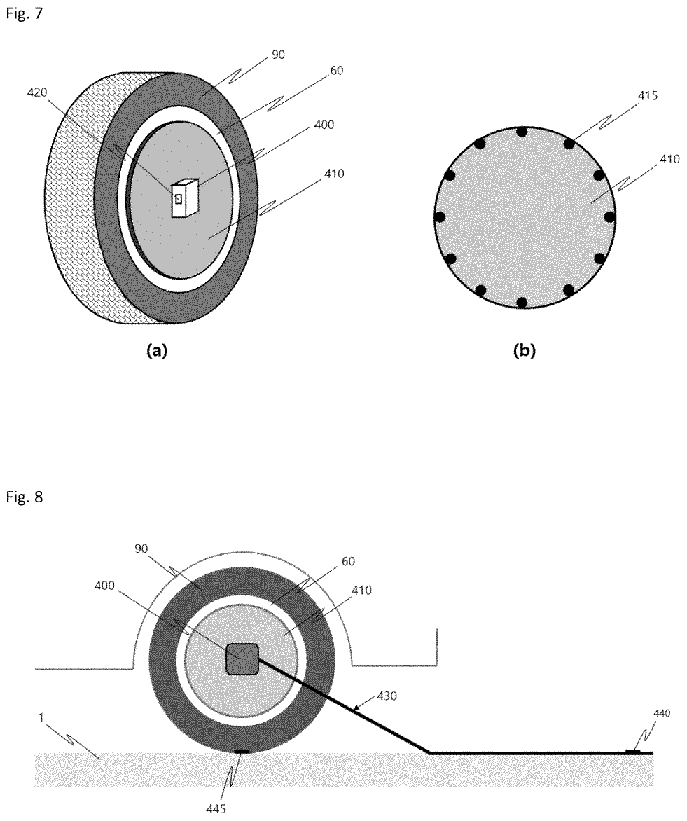

FIG. 7 illustrates an attachment disk with a laser level device attached to a wheel according to an embodiment of the present invention.

As in FIG. 7(a), a laser level device 400 may be attached to the center of the wheel 60 for a precise measurement experiment that projects a laser beam 430 parallel to the wheel 60, as shown in FIG. 8. The laser device 400 may be attached to the wheel 60 using an attachment disk 410, which includes disk magnets 415 on the back side of the attachment disk 410. The diameter of the attachment disk 410 may be less than or equal to the diameter of the wheel 60, and the disk magnets 415 may be attached to the edge on the back side of the attachment disk 410 as shown in FIG. 7(b). So, the attachment disk 410 with the laser level device 400 can be attached easily to the wheel 60, and after the measurement experiment, the attachment disk 410 can be easily detached.

The laser level device 400 may be attached to the front side of the attachment disk 410, as illustrated in FIG. 7(a). The laser beam projector 420 must be located at the center of the attachment disk 410. Moreover, the body of the laser level device 400 must be parallel to the attachment disk 410. So, after attaching the attachment disk 410 to the wheel 60, the laser beam 430 will be projected in parallel to the wheel 60. Also, the attachment disk 410 must be thick enough so that the body of the vehicle does not block the path of the laser beam 430 to the floor.

FIG. 8 depicts a side view of a front wheel with an attachment disk and its laser beam projected to the ground according to an embodiment of the present invention.

The attachment disk 410 is attached to the center of the wheel 60, and a laser beam 430 is projected forward from the laser level device 400 on the attachment disk 410. At some point, the laser beam 430 hits the floor 1 and projects a line thereon as shown in FIG. 8.

According to one embodiment of the present invention, two stick tapes 440, 445 are stuck to the floor parallel to the front axle 70, and the vehicle tires 90 must be located on one of the stick tapes 445 so that the vehicle faces the other stick tape 440, as shown in FIG. 8.

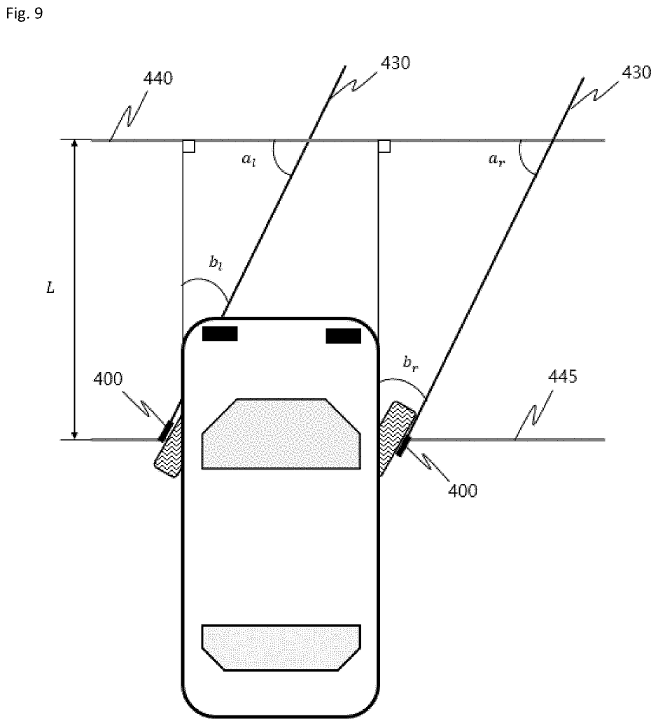

FIG. 9 illustrates the measurement setup of the front wheel angle according to an embodiment of the present invention.

According to one embodiment of the present invention, laser beams 430 are projected from the laser level device 400 parallel to the wheels 60 respectively. The laser beams 430 intersect the stick tapes 440, and the angles aₗ and aᵣ formed between the laser beams 430 and the stick tapes 440 can be measured, respectively. Then, with the help of geometry, the front wheel angles bᵣ and bₗ can be obtained from the measured angles aₗ and aᵣ. In other words, bₗ and bᵣ are π/2−aₗ and π/2−aᵣ, respectively.

The measurement setup of the wheel angle, as shown in FIG. 9, can be used for constructing the mapping table for a wire sensor 210 or a rotary angle sensor 250 of a sensing part 200. The mapping table can be constructed by measuring the wheel angle under the measurement setup of FIG. 9 and recording the corresponding output voltage of the wire sensor 210 or rotary angle sensor 250 while changing the wheel angle.

The measurement setup of the wheel angle of FIG. 9 can also be used for obtaining the lookup tables for f( ) and g( ), respectively.

According to one embodiment of the present invention, a lookup table for f( ) may be obtained by changing the FWA in steps, applying an actuation value to the actuation part for each FWA and measuring the new FWA for this case, in which the effect of g( ) is ignored. For example, the FWA may be changed by one degree, and while an actuation value is applied to each FWA, the changed FWA may be measured for obtaining the lookup table for f( ). When the FWA is at 0 degrees, the steering wheel 10 is turned to the right by applying an actuation value and the changed FWA is measured. Then, the steering ratio toward the right side at 0 degree may be obtained. Next, when the FWA is 1 degree, the steering wheel 10 is turned to the right by applying an actuation value and the changed FWA is measured. Then, the steering ratio toward right side at 1 degree may be obtained. By repeating this process, the lookup table for f( ) can be completed.

According to one embodiment of the present invention, a lookup table for g( ) may be obtained by changing the FWA in steps, applying an actuation value to the actuation part for each FWA, and measuring the new FWA for this case, while the effect of f( ) is deducted off by using the lookup table for f( ).

According to one embodiment of the present invention, when the desired FWA and the measured FWA are given, the corresponding values may be picked up from the lookup tables for f( ) and g( ) respectively, which may enable the precise control of the vehicle.

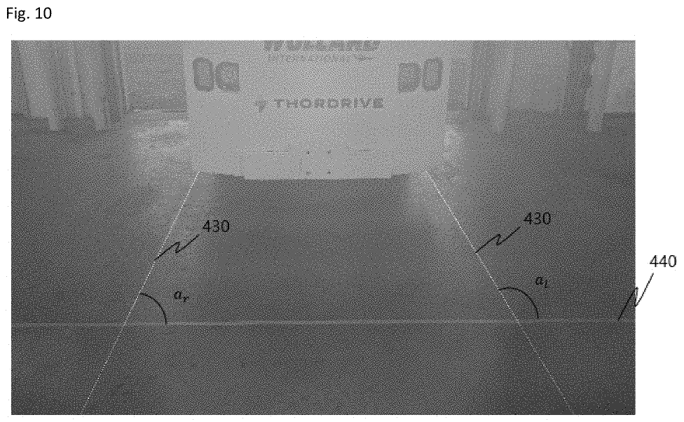

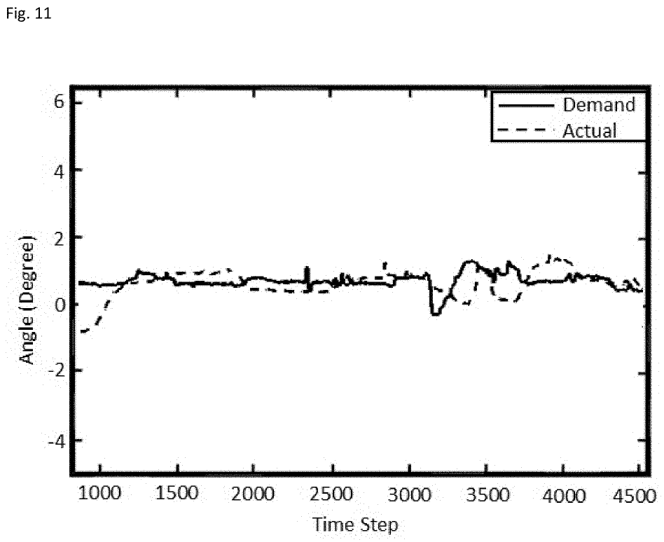

FIG. 10 is a real picture of the measurement setup of the FWA according to an embodiment of the present invention.

As shown in FIG. 10, the laser beams 430 intersect the stick tapes 440, and the angles aₗ and aᵣ are formed between the laser beams 430 and the stick tapes 440, respectively, which can be measured.

FIG. 11 illustrates desired and measured FWAs of a vehicle equipped with a steering system according to an embodiment of the present invention.

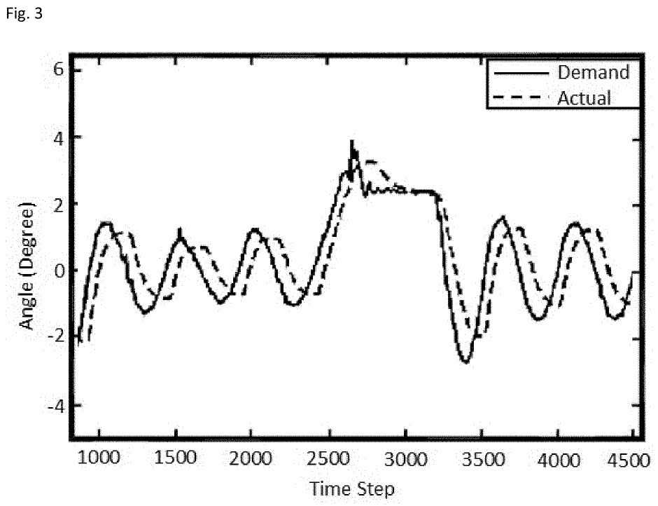

According to one embodiment of the present invention, the nonlinearity and response lag of the hydraulic steering system can be solved and an autonomous vehicle with the hydraulic steering system can be accurately controlled as shown in FIG. 11. FIG. 11 shows the results of the experiment conducted in the same setting as in FIG. 3, where there are many fewer discrepancies between desired FWA and measured FWA. This means that the autonomous vehicle has driven along the center of the lane more accurately.

Even though the steering system for a vehicle according to the present invention has been described above with reference to the drawings of the present application, the present invention is not limited to the structures and methods shown and described herein. Although the description has been made based on the front wheel for convenience of description, it is obvious to those skilled in the art that the same can be applied to steering of the rear wheel. Various hardware and/or software other than those disclosed herein may be used as a configuration of the present invention, and the scope of the rights is not limited to the configuration and method disclosed herein. Those skilled in the art will understand that various changes and modifications can be made within the scope of the object and effect pursued by the present invention. In addition, a part expressed in the singular or the plural in the present specification may be construed to include both the singular and the plural, except for essential cases.

What is claimed:

1. A control system for an autonomous vehicle with a nonlinear steering system, the system comprising:
a sensing part that measures the wheel angle;
a computing unit that calculates actuation values for the desired wheel angle based on the measured wheel angle; and
an actuation part that rotates the steering wheel according to the actuation value, wherein the actuation values are calculated based on a function f( ) representing the nonlinear behavior of the steering ratio depending on the position and movement direction of the steering wheel, and another function g( ) representing a response lag when the steering direction is changed.

2. The control system for an autonomous vehicle with a nonlinear steering system of claim 1,
the actuation part includes a DC motor actuator and a gearbox, which is linked to a steering column of the steering system.

3. The control system for an autonomous vehicle with a nonlinear steering system of claim 1,
the sensor part includes a wire sensor which measures the change of wire as the wheel rotates.

4. The control system for an autonomous vehicle with a nonlinear steering system of claim 1,
the sensor part includes a rotary angle sensor that measures the rotation angle of the wheel.

5. The control system for an autonomous vehicle with a nonlinear steering system of claim 1,
wherein the sensor part converts a measured value to the corresponding wheel angle by a mapping table.

6. The control system for an autonomous vehicle with a nonlinear steering system of claim 1,
wherein the functions f( ) and g( ) are expressed by lookup tables respectively, which are obtained by measuring the wheel angles with respect to the actuation values.

7. The control system for an autonomous vehicle with a nonlinear steering system of claim 6,
wherein the wheel angles are measured with a laser level device which is attached to the center of the wheel and projects a laser beam in parallel to the wheel.

8. The control system for an autonomous vehicle with a nonlinear steering system of claim 7,
wherein the laser level device is attached to the wheel by an attachment disk which includes disk magnets on its back side.

9. The control system for an autonomous vehicle with a nonlinear steering system of claim 7,
wherein the laser beam is projected to reach the floor.

10. The control system for an autonomous vehicle with a nonlinear steering system of claim 9,
wherein the attachment disk is thick enough so that the body of the vehicle does not block the path of the laser beam to the floor.

11. The control system for an autonomous vehicle with a nonlinear steering system of claim 9,
wherein the angle between the laser beam and a stick tape attached to the floor parallel to the front axle on the floor is measured and the wheel angle is obtained by subtracting the measured angle from 90 degrees.

12. The control system for an autonomous vehicle with a nonlinear steering system of claim 6,
wherein the lookup table for f( ) is obtained by changing the wheel angle by a predetermined unit angle, applying an actuation value to the actuation part for each wheel angle, and measuring the new wheel angle for this case, where the effect of g( ) is ignored.

13. The control system for an autonomous vehicle with a nonlinear steering system of claim 12,
wherein the lookup table for g( ) is obtained by changing the wheel angle by a predetermined unit angle, applying an actuation value to the actuation part for each wheel angle, and measuring the new wheel angle for this case, while the effect of f( ) is deducted off by using the lookup table for f( ).

14. A control method for an autonomous vehicle with a nonlinear steering system, the method comprising:
measuring wheel angles of the vehicle;
calculating the actuation value for the desired wheel angle based on the measured wheel angle; and
rotating the steering wheel according to the actuation value,
wherein the actuation values are calculated based on a function f( ) representing the nonlinear behavior of the steering ratio depending on the position and movement direction of the steering wheel, and another function g( ) representing a response lag when the steering direction is changed.

15. The control method for an autonomous vehicle with a nonlinear steering system of claim 14,
wherein the functions f( ) and g( ) are expressed by lookup tables, respectively, which are obtained by measuring the wheel angles with respect to the actuation values.

16. The control method for an autonomous vehicle with a nonlinear steering system of claim 15,
wherein the wheel angles are measured with a laser level device which is attached to the center of the wheel and projects a laser beam in parallel to the wheel to reach the floor.

17. The control method for an autonomous vehicle with a nonlinear steering system of claim 16,
wherein the angle between the laser beam and a stick tape attached to the floor parallel to the front axle on the floor is measured and the wheel angle is obtained by subtracting the measured angle from 90 degrees.

18. The control method for an autonomous vehicle with a nonlinear steering system of claim 15,
wherein the lookup table for f( ) is obtained by changing the wheel angle by a predetermined unit angle, applying an actuation value to the actuation part for each wheel angle, and measuring the new wheel angle for this case, where the effect of g( ) is ignored.

19. The control method for an autonomous vehicle with a nonlinear steering system of claim 17,
wherein the lookup table for g( ) is obtained by changing the wheel angle by a predetermined unit angle, applying an actuation value to the actuation part for each wheel angle, and measuring the new wheel angle for this case, while the effect of f( ) is deducted off by using the lookup table for f( ).

20. The control method for an autonomous vehicle with a nonlinear steering system of claim 14,
wherein the wheel angles are obtained by converting the output values of a sensor to the corresponding wheel angles by a mapping table.
